(19) United States
(12) Patent Application Publication
(10) Pub. No.: US 2008/0313456 A1
(43) Pub. Date: Dec. 18, 2008

(54) Apparatus and method for irrepudiable token exchange

(76) Inventors: Andrew John Menadue, Hampshire (GB); Raymond Jepson, Hampshire (GB); Barry John Wood, Hants (GB)

Correspondence Address: LAW OFFICES OF MICHAEL DRYJA, 1474 N COOPER RD #105-248, GILBERT, AZ, 85233, US

(21) Appl. No.: 12/138,183

(22) Filed: Jun. 12, 2008

(30) Foreign Application Priority Data
Jun. 12, 2007 (GB) 07110087.9

(51) Int. Cl. H04L 9/00

(52) U.S. Cl. 713/156

(57) ABSTRACT

A server apparatus is operable in communication with mobile client apparatuses for securely recording the occurrence of a transactional exchange meeting between holders of the mobile client apparatuses. A token component sets up a meeting arrangement mediated by the server and to communicate a first issued token to a first mobile client apparatus and a second issued token to a second mobile client apparatus. A token validator component receives at least a portion of each of the tokens from the mobile client apparatuses. The token validator component validates that the at least a portion of the token received from the first mobile client apparatus matches at least a portion of the second issued token, and vice-versa. A transaction recorder component creates and maintains a secure record of at least the request, the response, the validation of the tokens, and a completion signal from each of the mobile client apparatuses.

### RELATED PATENT APPLICATIONS

The present patent application claims priority to the previously filed United Kingdom patent application entitled “Apparatus and method for irrepudiable token exchange,” filed on Jun. 12, 2007, and assigned patent application number 07110087.9.

### FIELD OF THE INVENTION

The present invention relates generally to a technology for recording a transactional meeting between parties, and more particularly, to an apparatus and method for irrepudiably recording such a meeting.

### BACKGROUND OF THE INVENTION

Buying something on an online web site can involve the participants in a transaction having to meet and exchange goods, or the goods may be delivered by a commercial carrier from the supplier to a purchaser.

In the first case, to be absolutely sure that the transaction has taken place and that it can be verified in a court of law, a lot of preparation may have to be made to carefully select documents that can be used to identify both parties. Such documents can include at a minimum a passport or driver's license, as well as other forms of identification such as letters and bills showing proof of address. Having identified each other and satisfied themselves that each party is who they say they are the transaction may then go ahead. There may still, however, be a pitfall in that, for instance, buyers may claim they paid the money and never received the goods, or sellers may claim they were never given the payment. This may then lead to an expensive dispute, which in turn may lead to legal action.

In the second case, while commercial carriers such as the post office can track the delivery of the goods as far as the address of the purchaser, and online credit systems can verify the payment, there may still be some doubt about whether the goods were actually delivered to the correct person. For example, in the final stage of delivery the parcel may be handed over to incorrect persons simply because they were at the delivery address at the time.

While it may not be possible to completely solve these problems using any technological means, because of the human element involved, it may be possible to alleviate those parts of the problem associated with confirmation of the occurrence of the transactional meeting itself.

### SUMMARY OF THE INVENTION

The present invention provides for an apparatus and a method for irrepudiable token exchange. A server apparatus of one embodiment of the invention is operable in communication with mobile client apparatuses for securely recording the occurrence of a transactional exchange meeting between holders of the mobile client apparatuses. The server apparatus includes a token issuer component, a token validator component, and a transaction recorder component.

The token issuer component is responsive to a request and a response from the mobile client apparatuses. The token issuer component is operable to set up a meeting arrangement mediated by the server and to communicate a first issued token to a first mobile client apparatus of the mobile client apparatuses and a second issued token to a second mobile client apparatus of the mobile client apparatuses. The token validator component is operable to receive at least a portion of each of the tokens from the mobile client apparatuses responsive to a meeting occurrence.

The token validator component is further to validate that the at least a portion of the token received from the first mobile client apparatus matches at least a portion of the second issued token. The token validator component is further to validate that the at least a portion of the token received from the second mobile client apparatus matches at least a portion of the first issued token, and to signal the validation of the tokens to each of the holders of the mobile client apparatuses. The transaction recorder component is operable to create and maintain a secure record of at least the request, the response, the validation of the tokens, and a completion signal from each of the mobile client apparatuses.

A mobile client apparatus of one embodiment of the invention is operable in communication with a server apparatus having a transaction recorder component operable to create and maintain a secure record of the occurrence of a transactional exchange meeting with a holder of a second mobile client apparatus. The mobile client apparatus includes a requester/responder component, a token receiver component, a token sender component, a validation receiver component, and a completion signaler.

The requester/responder component is operable in communication with the server apparatus for setting up a meeting arrangement mediated by the server apparatus. The token receiver component is operable to receive a first token from the server apparatus. The token sender component is operable to send at least a portion of the first token to the second mobile client apparatus. The validation receiver component is operable to receive a validation signal from the server apparatus. The completion signaler is responsive to the receipt of the validation signal by the validation receiver component and is operable to send a completion signal to the server apparatus. The token receiver component is further operable to receive at least a portion of a second token from the second mobile client apparatus, whereas the token sender component is further operable to send the at least a portion of the second token to the server apparatus.

A method of one embodiment of the invention is for controlling a server apparatus, operable in communication with mobile client apparatuses for securely recording the occurrence of a transactional exchange meeting between holders of the mobile client apparatuses. Responsive to a request and a response from the mobile client apparatuses, the method sets up a meeting arrangement mediated by the server and communicates a first issued token to a first mobile client apparatus of the mobile client apparatuses and a second issued token to a second mobile client apparatus of the mobile client apparatuses.

The method receives at least a portion of each of the tokens from the mobile client apparatuses responsive to a meeting occurrence. The method validates that the at least a portion of the token received from the first mobile client apparatus matches at least a portion of the second issued token and that the at least a portion of the token received from the second mobile client apparatus matches at least a portion of the first issued token. The method signals the validation of the tokens to each of the holders of the mobile client apparatuses. The method also creates and maintains a secure record of at least the request, the response, the validation of the tokens, and a completion signal from each of the mobile client apparatuses.

A method of another embodiment of the invention is controlling a mobile client apparatus, operable in communication with a server apparatus having a transaction recorder component and operable to create and maintain a secure record of the occurrence of a transactional exchange meeting with a holder of a second mobile client apparatus. The method includes communicating with the server apparatus, by a requester/responder component, to set up a meeting arrangement mediated by the server apparatus.

A first token is received from the server apparatus. The at least a portion of the first token is sent to the second mobile client apparatus. At least a portion of a second token is received from the second mobile client apparatus. The at least a portion of the second token is sent to the server apparatus. A validation signal is received from the server apparatus. Responsive to the receipt of the validation signal by the validation receiver component, a completion signal is then sent to the server apparatus.

Embodiments of the invention thus contemplate, in their broadest aspect, a technology for recording a transactional meeting between parties, and more particularly, an apparatus and method for irrepudiably recording such a meeting. Still other aspects and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram depicting in schematic form a transactional exchange in accordance with an embodiment of the present invention.

FIG. 2 is a diagram depicting in schematic form an apparatus or arrangement of apparatus in accordance with an embodiment of the present invention.

FIG. 3 is a flowchart of one method or logic arrangement in which an embodiment of the present invention may be implemented.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

One embodiment of the invention is suitably implemented in a transactional server system operable to communicate with the two parties to a transaction, and preferably operable to communicate wirelessly with devices carried by the parties. Furthermore, one embodiment of the present invention, which can be in the form of an apparatus or arrangement of apparatuses, advantageously addresses the problem of providing a technical means for recording a transactional meeting between parties, and more particularly, of providing an apparatus for irrepudiably recording such a meeting.

In one embodiment, broadly stated, an intermediary such as an auction site issues each party with a two-part token that they then use to verify that the other person is indeed the person they have set out to meet. Each party only knows its own token and the two tokens are different, so there is no way that one party could gain access to a correct token purporting to be that of the other party. Once a meeting is to be confirmed, each token may, for example, be split into two, and one half of each be swapped between meeting members. Messages containing the token halves are then sent to a server, which verifies that the tokens are correct and sends out messages to the meeting members indicating success, if the tokens match its records. If the tokens do not match then the message is a failure message.

The database record that the server holds about each meeting may take the following form:
Meeting Database Record
   Meeting ID
   Party A ID
   Party B ID
   Meeting State
      Additional information about the time and location of the meeting could also be added if desired. There may also be more than two parties involved in the meeting.

An advantage of one embodiment of the invention is that a meeting can be arranged independently by simply requesting a meeting be set up using the data base and its associated calendar system. If the meeting is agreed by both parties and the credentials are satisfactory then the system further allows the electronic tokens to be stored within a mobile device such as a phone or personal digital assistant (PDA) that can run software to make an actual identification when the two devices come within close proximity of each other and are able to confirm the identity of the previously unknown person at the location and time of the meeting.

If they want to use the service, both parties register on the web site that they require the transaction to be fully audited. At that time the request is recorded in to a database, together with details about how the goods will be exchanged, such as time and place, and so on. The audit service site then issues each party with a two-part token that they then use to verify that the other person is indeed the person they have set out to meet. This could be in the form of some data such as a unique token being sent to the owner's mobile phone. The sending of the tokens and messages to the server is recorded together with the time and if available the cellular location that the transaction took place.

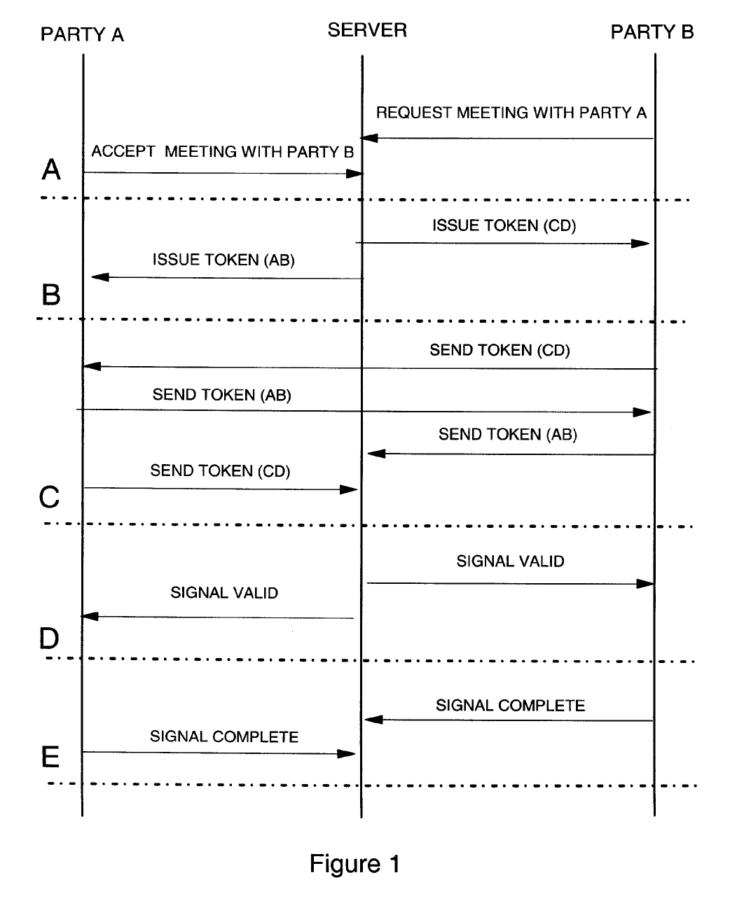

To explain the above with reference now to the figures, FIG. 1 shows in schematic form a transactional exchange in accordance with one embodiment of the present invention, in which events occur in a top-down sequence. Party B requests the server to set up a meeting with Party A, Party A accepts the meeting request, and the server is thus instructed to create a meeting at the completion of time period A of FIG. 1.

The server then generates a meeting database record and associates two tokens with this record. These tokens are issued to the two parties and the meeting is then able to take place. The server sets its database state for this meeting to PENDING. This completes time period B of FIG. 1. When the two parties meet, they exchange the tokens, or the halves of the tokens, that they were sent. The exchanged tokens or half-tokens are then sent on by each recipient to the server. This is shown as time period C in FIG. 1.

The server then verifies that these two tokens or half-tokens are correctly associated with this meeting and if they are, the server sends a VALID message to both parties. This indicates to the parties that the meeting is valid and can start. The server sets the database record for this meeting to VALID. This is shown as time period D in FIG. 1. Once the purpose of the meeting has been concluded, for instance when an exchange of goods and money has taken place, both parties send a COMPLETED message to the server. The meeting has now successfully concluded. The server notes this in its database record. This is shown as time period E in FIG. 1.

It will be clear to one of ordinary skill in the art that this method can rely on a central repository of information, accessible by the exemplary server, which is used to verify identity. This repository is accessed by the server that handles messages from the meeting members. These could be sent over short-message service SMS (SMS), email, or any other suitable means. The identity of the members is defined by the information in the repository and the reliability of the system is thus only as good as the information it contains, but this is conventional in such systems and techniques are in place to address this issue. The information would have to be verified in some manner to a level that is acceptable for the applications that the system is applied to. For example, any well-known trusted-party system may be used as the verification means.

The intention to have a meeting may be set up in the server either manually, such as in the case of a meeting not associated with any other transaction, or automatically, such as in the case of an online auction using an internet application. Tokens for the meeting members are generated at this point and sent to the parties involved.

An image of the meeting members could also be sent as an aid to identifying the people that are to meet. This additional refinement depends on the capabilities of the hardware the parties are using. As another aid to the confirmation of the meeting, the well-known Bluetooth communication facility of modern cellular phones could be used to indicate when a meeting member is nearby.

The tokens that the two parties are sent can be a simple numeric or alphabetic code or an encrypted sequence. The tokens may be sent in an SMS text message. The two halves of each token could be sent in separate messages. This potentially makes it easier for the swapping of part of the token between meeting members.

In such an embodiment, when the two parties meet, they swap token halves and each generates a composite token, which it sends to the server, which then compares the composite tokens with a meeting record and sends both parties a reply confirming that the composite tokens have matched and the meeting is valid, or that they do not match and it is not a valid meeting. These two tokens may have to be received within a certain time of each other. If one is sent and the other one is not sent then a failure message is sent. So, for instance, if one token is sent and the other has not been received within, say, a minute, then a failure message is sent to both parties.

In a further refinement, the system could be extended to more than two parties in a meeting. To do that and exchange tokens between all members of the meeting would probably involve some hardware assistance, such as Bluetooth communication between all meeting members' phones in order to be practical.

As has been suggested above, an enhancement of the token exchange is that they could be passed automatically between devices owned by the meeting parties. This would require that a mobile phone, wireless or Bluetooth device contained a program that could store and exchange the tokens and providing both parties were carrying similarly-equipped devices running compatible programs the token exchange could take place when the people that are due to meet came within some transmission range of each other. A technology for sensing proximity between devices equipped with wireless means is known from, for example, published international patent application WO 2006/064265 A1. In this case, when the proximity of the corresponding device enables tokens to be exchanged an alert could appear on the phone indicating that the person you intend to meet is near by and identified. If during the exchange a portrait photo was sent between each phone then a visual identification of the person could be made before the actual meeting took place, and before the exchanged tokens are sent on to the server.

The advantages of one embodiment of the invention thus include providing an irrefutable, computer-based system that will ensure the people are who they say they are, and provide an audit trail of the transaction which will record the fact that the two parties wish to meet at a certain time in a specified location to make the transaction, provide a method of identifying each other at the time of the transaction and record the fact that the transaction did indeed take place. The system may also generate warning alerts to either party if any of the conditions is not met.

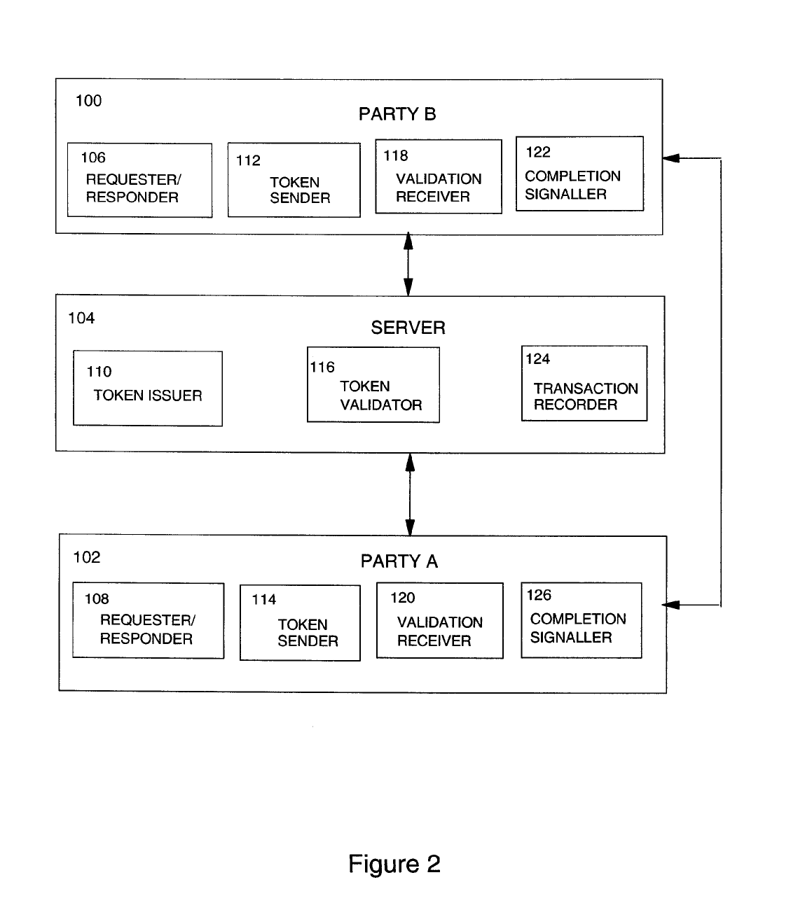

Turning now to FIG. 2, there is an apparatus or arrangement of apparatus in accordance with one embodiment of the present invention. Two exemplary parties is in possession of apparatuses 100 and 102, associated respectively with PARTY B and PARTY A. Each of the apparatuses 100 and 102 is operable to communicate with a server 104. Apparatus 100 and apparatus 102 are also operable to communicate with one another.

In one embodiment, apparatus 100 has a requester/responder component 106 operable to transmit a request for a meeting to server 104, and apparatus 102 has a requester/responder component 108 operable to transmit an acceptance to server 104. The transmission of the acceptance may be made in response to a passing-on of the request to apparatus 102 by server 104 or in response to a copy of the request sent by apparatus 100. Responsive to receipt of a request and a response relating to a single meeting, server 104 creates a pending meeting record using some form of transaction recording in a storage means such as a database, shown in FIG. 2 as transaction recorder component 122.

Server 104 also has a token issuer 110, which is responsible for issuing tokens to apparatus 100 and apparatus 102 and for maintaining a record of the tokens issued, preferably in the meeting record held by transaction recorder 124. On receipt of the tokens and when they are ready to initiate the meeting, apparatus 100 and apparatus 102 are operable to exchange tokens by the use of token senders 112 and 114 and each then to transmit the token it has received in the exchange to the server 104 by the use of token senders 112 and 114. Server 104 receives the tokens and calls token validator 116 to validate the tokens, with reference to the meeting record held by transaction recorder 122. If the tokens are valid and the meeting has thus successfully taken place, token validator 116 is operable to send a “meeting valid” notice to the validation receivers 118 and 120 of apparatus 100 and 102.

On receipt of the validation messages from server 104, apparatus 100 and apparatus 102 are operable to invoke, respectively, completion signaler 122 and completion signaler 126 to notify server 104 that the transactional exchange associated with the meeting has been completed. Server 104 is then further operable to make a secure record of the meeting's successful completion in the meeting record held by transaction recorder 124.

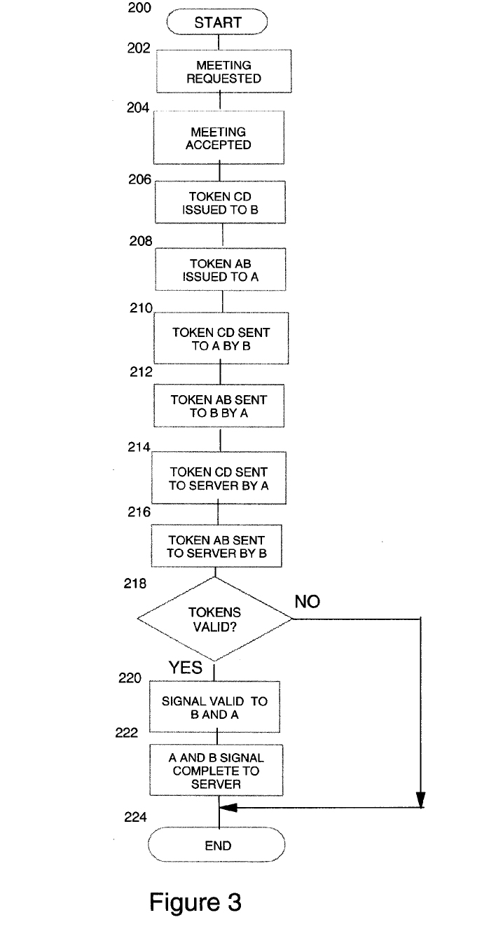

Turning now to FIG. 3, there is shown in flowchart form a method or logic arrangement according to one embodiment of the present invention. The method or the logic elements of the logic arrangement start operation at START part 200. At part 202, a meeting is requested and at part 204 the meeting is accepted. At parts 206 and 208, tokens are issued to party B and party A respectively. At parts 210 and 212, the tokens or half-tokens are exchanged by parties A and B, and at parts 214 and 216, each of the parties sends the token or half-token it has received from the other party to the server. At part 218, the server tests the tokens for validity.

If the tokens or half-tokens are not valid, the server ends the process. It will be clear to one of ordinary skill in the art that the server may carry out additional processes associated with a meeting that has failed because of an invalid token exchange, but details of these additional processes are not described here. If the tokens are found to be valid at test part 218, the server sends a “valid” signal to each of the parties, and at part 222, when the transactional exchange is completed, each of the parties sends a “complete” signal to the server. The server may then preferably store its record of the meeting in such a manner as to form an irrepudiable record of the complete token exchange, using any of a number of well-known techniques for making such a record, including, but not limited to, secure digital time stamping, the use of a trusted third party or “digital notary” system, or the like.

One embodiment of the present invention in the form of a method or logic arrangement thus advantageously addresses the problem of providing a technical means for recording a transactional meeting between parties, and more particularly, of providing a method for irrepudiably recording such a meeting. However, it will be clear to one of ordinary skill in the art that all or part of the method of embodiments of the present invention may suitably and usefully be embodied in a logic apparatus, or a number of logic apparatuses, having logic elements arranged to perform the method and that such logic elements may include hardware components, firmware components or a combination thereof.

It will be equally clear to one of skill in the art that all or part of a logic arrangement according to embodiments of the present invention may suitably be embodied in a logic apparatus having logic elements to perform the method, and that such logic elements may include components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise include storage media of all descriptions as well as signal-carrying media, such as wired or wireless signal-carrying media.

The present invention may further suitably be embodied as a computer program product for use with a computer system. Such an implementation may include a series of computer-readable instructions either fixed on a tangible medium, such as a computer readable medium, for example, diskette, compact disc read-only memory (CD-ROM), ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In an alternative, an embodiment of the present invention may be realized in the form of a computer implemented method of deploying a service including deploying computer program code operable to, when deployed into a computer infrastructure and executed thereon, cause the computer infrastructure to perform the method. In a further alternative, an embodiment of the present invention may be realized in the form of a data carrier having functional data thereon, the functional data having functional computer data structures to, when loaded into a computer system and operated upon thereby, enable the computer system to perform the method. It thus will be clear to one skilled in the art that many improvements and modifications can be made to the foregoing exemplary embodiment without departing from the scope of the present invention.

1. A server apparatus, operable in communication with a plurality of mobile client apparatuses for securely recording the occurrence of a transactional exchange meeting between holders of the mobile client apparatuses, and comprising:
a token issuer component responsive to a request and a response from the plurality of mobile client apparatuses and operable to set up a meeting arrangement mediated by the server and to communicate a first issued token to a first mobile client apparatus of the plurality of mobile client apparatuses and a second issued token to a second mobile client apparatus of the plurality of mobile client apparatuses;
a token validator component operable to receive at least a portion of each of the plurality of tokens from the plurality of mobile client apparatuses responsive to a meeting occurrence, to validate that the at least a portion of the token received from the first mobile client apparatus matches at least a portion of the second issued token and that the at least a portion of the token received from the second mobile client apparatus matches at least a portion of the first issued token, and to signal the validation of the plurality of tokens to each of the holders of the mobile client apparatuses; and
a transaction recorder component operable to create and maintain a secure record of at least the request, the response, the validation of the plurality of tokens, and a completion signal from each of the plurality of mobile client apparatuses.

2. The server apparatus of claim 1, further comprising a mechanism to communicate with a trusted third party system and to confirm identities of each of the holders of the mobile client apparatuses.

3. The server apparatus of claim 1, further comprising a mechanism to communicate with a digital notarization system to receive a certification of at least one of the time or the date of the transactional exchange meeting.

4. The server apparatus of claim 1, further comprising a mechanism to issue a humanly-understandable mechanism for identifying at least one of the holders of the mobile client apparatuses.

5. The server apparatus of claim 1, wherein the token issuer component is operable to issue tokens having an expiry time-limit.

6. The server apparatus of claim 5, wherein the token validator component is operable to refuse validation of tokens having exceeded the expiry time-limit.

7. The server apparatus of claim 1, wherein the at least a portion of each of the plurality of tokens comprises a half portion.

8. The server apparatus of claim 1, wherein the at least a portion of each of the plurality of tokens comprises a whole token.

9. A mobile client apparatus, operable in communication with a server apparatus having a transaction recorder component operable to create and maintain a secure record of the occurrence of a transactional exchange meeting with a holder of a second mobile client apparatus, and comprising:
a requester/responder component operable in communication with the server apparatus for setting up a meeting arrangement mediated by the server apparatus;
a token receiver component operable to receive a first token from the server apparatus;
a token sender component operable to send at least a portion of the first token to the second mobile client apparatus;
a validation receiver component operable to receive a validation signal from the server apparatus; and
a completion signaler responsive to the receipt of the validation signal by the validation receiver component and operable to send a completion signal to the server apparatus,
wherein the token receiver component is further operable to receive at least a portion of a second token from the second mobile client apparatus,
and wherein the token sender component operable to send the at least a portion of the second token to the server apparatus.

10. The mobile client apparatus of claim 9, further comprising a mechanism to receive a humanly-understandable mechanism for identifying a holder of the mobile client apparatus.

11. The mobile client apparatus of claim 9, wherein the token sender component is responsive to a proximity detector detecting proximity to the second mobile client apparatus.

12. The mobile client apparatus of claim 9, wherein the at least a portion of each of the plurality of tokens comprises a half portion.

13. The mobile client apparatus of claim 9, wherein the at least a portion of each of the plurality of tokens comprises a whole token.

14. A method for controlling a server apparatus, operable in communication with a plurality of mobile client apparatuses for securely recording the occurrence of a transactional exchange meeting between holders of the mobile client apparatuses, and comprising:
responsive to a request and a response from the plurality of mobile client apparatuses, setting up a meeting arrangement mediated by the server and communicating a first issued token to a first mobile client apparatus of the plurality of mobile client apparatuses and a second issued token to a second mobile client apparatus of the plurality of mobile client apparatuses;
receiving at least a portion of each of the plurality of tokens from the plurality of mobile client apparatuses responsive to a meeting occurrence, validating that the at least a portion of the token received from the first mobile client apparatus matches at least a portion of the second issued token and that the at least a portion of the token received from the second mobile client apparatus matches at least a portion of the first issued token, and signaling the validation of the plurality of tokens to each of the holders of the mobile client apparatuses; and
creating and maintaining a secure record of at least the request, the response, the validation of the plurality of tokens, and a completion signal from each of the plurality of mobile client apparatuses.

15. The method of claim 14, further comprising communicating with a trusted third party system for confirming identities of each of the holders of the mobile client apparatuses.

16. The method of claim 14, further comprising communicating with a digital notarization system for receiving a certification of at least one of the time or the date of the transactional exchange meeting.

17. The method of claim 14, further comprising issuing a humanly-understandable means for identifying at least one of the holders of the mobile client apparatuses.

18. A method of controlling a mobile client apparatus, operable in communication with a server apparatus having a transaction recorder component operable to create and maintain a secure record of the occurrence of a transactional exchange meeting with a holder of a second mobile client apparatus, and comprising:
communicating with the server apparatus, by a requester/responder component, to set up a meeting arrangement mediated by the server apparatus;
receiving a first token from the server apparatus;
sending at least a portion of the first token to the second mobile client apparatus;
receiving at least a portion of a second token from the second mobile client apparatus;
sending the at least a portion of the second token to the server apparatus;
receiving a validation signal from the server apparatus; and
responsive to the receipt of the validation signal by the validation receiver component, sending a completion signal to the server apparatus.

19. The method of claim 18, further comprising receiving a humanly-understandable mechanism for identifying a holder of the second mobile client apparatus.

20. The method of claim 14, wherein sending at least the portion of the first token to the second mobile client apparatus is responsive to a proximity detector detecting proximity to the second mobile client apparatus.
